(19) United States
(12) Patent Application Publication
(10) Pub. No.: US 2024/0404061 A1
(43) Pub. Date: Dec. 5, 2024

(54) DETECTION OF ARTIFACTS IN SYNTHETIC MEDICAL IMAGES

(71) Applicant: BAYER AKTIENGESELLSCHAFT, Leverkusen (DE)

(72) Inventors: Matthias LENGA, Leverkusen (DE); Ivo Matteo BALTRUSCHAT, Leverkusen (DE)

(21) Appl. No.: 18/732,938

(22) Filed: Jun. 4, 2024

(30) Foreign Application Priority Data
Jun. 5, 2023 (EP) 23177300.3

(51) Int. Cl. G06T 7/00; G06T 7/90; G06T 11/00; G06T 11/60

(52) U.S. Cl. CPC G06T 7/0014; G06T 7/90; G06T 11/001; G06T 11/60; G06T 2207/10024; G06T 2207/10081; G06T 2207/10088; G06T 2207/10132; G06T 2207/20081; G06T 2207/20212; G06T 2207/30004; G06T 2210/41

(57) ABSTRACT

The present disclosure relates to the technical field of generation of synthetic medical images. The subjects of the present disclosure are a method, a computer system and a computer-readable storage medium comprising a computer program for detecting artifacts in synthetic medical images.

### CROSS-REFERENCE TO RELATED APPLICATIONS

This application claims priority to European Patent Application No. 23177300.3, filed Jun. 5, 2023, the content of which is incorporated herein by reference in its entirety.

### FIELD OF THE DISCLOSURE

The present disclosure relates to the technical field of generation of synthetic medical images. The subjects of the present disclosure are a method, a computer system and a computer-readable storage medium comprising a computer program for detecting artifacts in synthetic medical images.

### BACKGROUND

Artificial intelligence is being increasingly adopted by medicine. Machine-learning models are not only being used to identify signs of disease in medical images of the human or animal body (see, for example, WO 2018/202541 A1, WO 2020/229152 A1), but are also being increasingly used to generate synthetic (artificial) medical images.

For example, WO 2021/052896 A1 and WO 2021/069338 A1 describe methods for generating an artificial medical image showing an examination region of an examination object in a first period of time. The artificial medical image is generated with the aid of a trained machine-learning model on the basis of medical images showing the examination region in a second period of time. The method can be used, for example, to speed up radiological examinations; instead of measuring radiological images over a relatively long period of time, measurements are only made within one portion of the period of time and one or more radiological images are predicted for the remaining portion of the period of time with the aid of the trained model.

For example, WO 2019/074938 A1 and WO 2022/184297 A1 describe methods for generating an artificial radiological image showing an examination region of an examination object after the administration of a standard amount of a contrast agent, even though only a lower amount of contrast agent than the standard amount has been administered. The standard amount is the amount recommended by the manufacturer and/or distributor of the contrast agent and/or the amount approved by a regulatory authority and/or the amount specified in a package leaflet for the contrast agent. The methods described in WO 2019/074938 A1 and WO 2022/184297 A1 can therefore be used to reduce the amount of contrast agent.

The medical images generated by the trained machine-learning models may contain errors (see for example: K. Schwarz et al.: On the Frequency Bias of Generative Models, https://doi.org/10.48550/arXiv.2111.02447).

Such errors can be problematic, since a doctor might make a diagnosis and/or initiate therapy on the basis of the artificial medical images. When reviewing artificial medical images, a doctor needs to know whether features in the artificial medical images are due to real features of the examination object or whether they are artifacts due to errors in prediction by the trained machine-learning model.

### SUMMARY

These and other problems are addressed by the subjects of the present disclosure.

The present disclosure provides in a first aspect a computer-implemented method for generating at least one confidence value for a synthetic image, comprising:
receiving at least one image of an examination region of an examination object, wherein the at least one image comprises a plurality of image elements, wherein each image element of the plurality of image elements represents a sub-region of the examination region;
generating a plurality of different modifications of the at least one received image;
generating a plurality of synthetic images of the examination region of the examination object on the basis of the modifications by means of a generative model, wherein each synthetic image comprises a plurality of image elements, wherein each image element of the plurality of image elements represents a sub-region of the examination region, wherein each image element is assigned at least one color value;
determining a measure of dispersion of the color values of corresponding image elements of the generated synthetic images, wherein mutually corresponding image elements represent the same sub-region of the examination region;
determining at least one confidence value on the basis of the determined measure of dispersion; and
outputting the at least one confidence value and/or an item of information based on the at least one confidence value.

The present disclosure further provides a computer system comprising:
a processor and
a memory that stores an application program configured to perform an operation when executed by the processor, said operation comprising:
   receiving at least one image of an examination region of an examination object, wherein the at least one image comprises a plurality of image elements, wherein each image element of the plurality of image elements represents a sub-region of the examination region;
   generating a plurality of different modifications of the at least one received image;
   generating a plurality of synthetic images of the examination region of the examination object on the basis of the modifications by means of a generative model, wherein each synthetic image comprises a plurality of image elements, wherein each image element of the plurality of image elements represents a sub-region of the examination region, wherein each image element is assigned at least one color value;
   determining a measure of dispersion of the color values of corresponding image elements of the generated synthetic images, wherein mutually corresponding image elements represent the same sub-region of the examination region;
   determining at least one confidence value on the basis of the determined measure of dispersion; and
   outputting the at least one confidence value and/or an item of information based on the at least one confidence value.

The present disclosure further provides a computer-readable storage medium comprising a computer program which can be loaded into a working memory of a computer system, where it causes the computer system to execute the following:
receiving at least one image of an examination region of an examination object, wherein the at least one image comprises a plurality of image elements, wherein each image element of the plurality of image elements represents a sub-region of the examination region;
generating a plurality of different modifications of the at least one received image;
generating a plurality of synthetic images of the examination region of the examination object on the basis of the modifications by means of a generative model, wherein each synthetic image comprises a plurality of image elements, wherein each image element of the plurality of image elements represents a sub-region of the examination region, wherein each image element is assigned at least one color value;
determining a measure of dispersion of the color values of corresponding image elements of the generated synthetic images, wherein mutually corresponding image elements represent the same sub-region of the examination region;
determining at least one confidence value on the basis of the determined measure of dispersion; and
outputting the at least one confidence value and/or an item of information based on the at least one confidence value.

### BRIEF DESCRIPTION OF THE DRAWINGS

FIG. 1 shows by way of example and in schematic form the generation of modifications of received images, the generation of a plurality of synthetic images on the basis of the modifications with the aid of a generative model, and the generation of a combined synthetic image on the basis of the plurality of synthetic images.

FIG. 2 shows by way of example and in schematic form the combination of synthetic images to form a combined synthetic image.

FIG. 3 shows by way of example and in schematic form the determination of the at least one confidence value and the generation of a confidence representation.

FIG. 4 shows one embodiment of the method of the present disclosure in the form of a flowchart.

FIG. 5 shows by way of example and in schematic form a method for training a machine-learning model.

FIG. 6 shows by way of example and in schematic form a computer system according to the present disclosure.

FIG. 7 shows by way of example and in schematic form a further embodiment of the computer system of the present disclosure.

### DETAILED DESCRIPTION

The disclosure will be more particularly elucidated below without distinguishing between the subjects of the present disclosure (method, computer system, computer-readable storage medium). Rather, the following statements shall apply mutatis mutandis to all the subjects of the disclosure, irrespective of the context (method, computer system, computer-readable storage medium) in which they are described.

Where steps are stated in an order in the present description or in the claims, this does not necessarily mean that the disclosure is limited to the order stated. Rather, it is conceivable that the steps can also be executed in a different order or else in parallel with one another, unless one step builds on another step, which absolutely requires that the step building on the previous step be executed subsequently (this will, however, become clear in the individual case).

In certain places the disclosure will be more particularly elucidated with reference to drawings. The drawings show specific embodiments having specific features and combinations of features, which are intended primarily for illustrative purposes; the disclosure is not to be understood as being limited to the features and combinations of features shown in the drawings. Furthermore, statements made in the description of the drawings in relation to features and combinations of features are intended to be generally applicable, that is to say transferable to other embodiments too and not limited to the embodiments shown.

The present disclosure describes means for judging the trustworthiness of a synthetic image of an examination region of an examination object.

The term “trustworthiness” is understood to mean that a person reviewing the synthetic image is able to trust that structures and/or morphologies and/or textures depicted in the synthetic image are attributable to real structures and/or real morphologies and/or real textures of the examination region of the examination subject and are not artifacts.

The term “synthetic” as used herein may refer to a synthetic image that is not the direct result of a measurement on a real examination object, but has been artificially generated (calculated). However, a synthetic image can be based on images taken of a real examination object, i.e. one or more images taken of a real examination object can be used to generate the synthetic image. Examples of synthetic images are described in the introduction and in the further description of the present disclosure. According to the present disclosure, a synthetic image is generated by a machine-learning model. The generation of a synthetic image with the aid of a machine-learning model is also referred to as “prediction” in this description. The terms “synthetic” and “predicted” are used synonymously in this disclosure. In other words, a synthetic image is an image generated by a (trained) machine-learning model on the basis of input data, which can comprise one or more images generated by measurement.

The “examination object” is preferably a human or an animal, preferably a mammal, most preferably a human.

The “examination region” is part of the examination object, for example an organ of a human or animal such as the liver, brain, heart, kidney, lung, stomach, intestines, pancreas, thyroid gland, prostate, breast, or part of the aforementioned organs, or multiple organs, or another part of the examination object. The examination region may also include multiple organs and/or parts of multiple organs.

In one embodiment, the examination region includes a liver or part of a liver or the examination region is a liver or part of a liver of a mammal, preferably a human.

In a further embodiment, the examination region includes a brain or part of a brain or the examination region is a brain or part of a brain of a mammal, preferably a human.

In a further embodiment, the examination region includes a heart or part of a heart or the examination region is a heart or part of a heart of a mammal, preferably a human.

In a further embodiment, the examination region includes a thorax or part of a thorax or the examination region is a thorax or part of a thorax of a mammal, preferably a human.

In a further embodiment, the examination region includes a stomach or part of a stomach or the examination region is a stomach or part of a stomach of a mammal, preferably a human.

In a further embodiment, the examination region includes a pancreas or part of a pancreas or the examination region is a pancreas or part of a pancreas of a mammal, preferably a human.

In a further embodiment, the examination region includes a kidney or part of a kidney or the examination region is a kidney or part of a kidney of a mammal, preferably a human.

In a further embodiment, the examination region includes one or both lungs or part of a lung of a mammal, preferably a human.

In a further embodiment, the examination region includes a breast or part of a breast or the examination region is a breast or part of a breast of a female mammal, preferably a female human.

In a further embodiment, the examination region includes a prostate or part of a prostate or the examination region is a prostate or part of a prostate of a male mammal, preferably a male human.

The examination region, also referred to as the field of view (FOV), is in particular a volume that is imaged in radiological images. The examination region is typically defined by a radiologist, for example on a localizer image. It is also possible for the examination region to be alternatively or additionally defined in an automated manner, for example on the basis of a selected protocol.

The term “image” refers to a data structure constituting a spatial distribution of a physical signal. The spatial distribution can have any dimension, for example 2D, 3D, 4D or a higher dimension. The spatial distribution can have any form, for example it can form a grid, which can be irregular or regular, and thereby define pixels or voxels. The physical signal can be any signal, for example proton density, echogenicity, permeability, absorption capacity, relaxivity, information about rotating hydrogen nuclei in a magnetic field, color, grey level, depth, surface or volume occupancy.

The term “image” is preferably understood to mean a two-, three- or higher-dimensional visually capturable representation of the examination region of the examination object. The received image is usually a digital image. The term “digital” as used herein may mean that the image can be processed by a machine, generally a computer system. “Processing” is understood to mean the known methods for electronic data processing (EDP).

A digital image can be processed, edited and reproduced and also converted into standardized data formats, for example JPEG (graphics format of the Joint Photographic Experts Group), PNG (Portable Network Graphics) or SVG (Scalable Vector Graphics), by means of computer systems and software. Digital images can be visualized by means of suitable display devices, for example computer monitors, projectors and/or printers.

In a digital image, image contents are usually represented by whole numbers and stored. In most cases, the images are two- or three-dimensional images, which can be binary coded and optionally compressed. The digital images are usually raster graphics, in which the image information is stored in a uniform raster grid. Raster graphics consist of a raster arrangement of so-called picture elements (pixels) in the case of two-dimensional representations or volume elements (voxels) in the case of three-dimensional representations. In the case of four-dimensional representations, the term doxel (dynamic voxel) is commonly used for the image elements. In the case of higher-dimensional representations or in general, the term “n-xel” is sometimes also used, where n indicates the particular dimension. This disclosure uses generally the term image element. An image element can therefore be a picture element (pixel) in the case of a two-dimensional representation, a volume element (voxel) in the case of a three-dimensional representation, a dynamic voxel (doxel) in the case of the four-dimensional representation or a higher-dimensional image element in the case of a higher-dimensional representation.

Each image element in an image is assigned a color value. The color value indicates how (e.g. in what color) the image element is to be visually displayed (e.g. on a monitor).

The simplest case is a binary image, in which an image element is displayed either white or black. The color value “0” is usually “black” and the color value “1” “white”.

In the case of a grey scale image, each image element is assigned a grey level, which ranges from black to white over a defined number of shades of grey. Grey levels are also referred to as grey values. The number of shades can range, for example, from 0 to 255 (i.e. 256 grey levels/grey values), and here too, the value “0” is usually “black” and the highest grey value (value of 255 in this example) “white”.

In the case of a color image, the color coding used for an image element is defined, inter alia, in terms of the color space and the color depth. In the case of an image, the color of which is defined in terms of the so-called RGB color space (RGB stands for the primary colors red, green and blue), each picture element is assigned three color values, one color value for the color red, one color value for the color green and one color value for the color blue. The color of an image element arises through the superimposition (additive blending) of the three color values. The individual color value can be discretized, for example, into 256 distinguishable levels, which are called tonal values and usually range from 0 to 255. The tonal value “0” of each color channel is usually the darkest color nuance. If all three color channels have the tonal value 0, the corresponding image element appears black; if all three color channels have the tonal value 255, the corresponding image element appears white.

Irrespective of whether the image is a binary image, a grey scale image or a color image, the term “color value” is used in this disclosure to indicate the color (including the “colors” “black” and “white” and all shades of grey) in which an image element is to be displayed. A color value can thus be a tonal value of a color channel, a shade of grey, or “black” or “white”.

A color value in an image (especially a medical image) usually represents a strength of a physical signal (see above). It should be noted that the “color value” can also be a value for the physical signal itself.

There are a multiplicity of possible digital image formats and color codings. For simplification, it is assumed in this description that the present images are raster graphics having a specific number of image elements. However, this assumption ought not in any way be understood as limiting. It is clear to a person skilled in the art of image processing how the teaching of this description can be applied to image files which are present in other image formats and/or in which the color values are coded differently.

An “image” in the context of the present disclosure can also be one or more excerpts from a video sequence.

In a first step, at least one image of an examination region of an examination object is received.

The term “receiving” encompasses both the retrieving of images and the accepting of images transmitted, for example, to the computer system of the present disclosure. The at least one image can be received from a computed tomography scanner, from a magnetic resonance imaging scanner, from an ultrasound scanner, from a camera and/or from some other device for generating images. The at least one image can be read from a data memory and/or transmitted from a separate computer system.

Preferably, the at least one received image is a two-dimensional or three-dimensional representation of an examination region of an examination object.

In one embodiment of the present disclosure, the at least one received image is a medical image.

A “medical image” is a visual representation of an examination region of a human or animal that can be used for diagnostic and/or therapeutic purposes.

There is a multitude of techniques that can be used to generate medical images; examples of such techniques include radiography, computed tomography (CT), fluoroscopy, magnetic resonance imaging (MRI), ultrasound (sonography), endoscopy, elastography, tactile imaging, thermography, microscopy, positron emission tomography, optical coherence tomography (OCT), fundus photography and others.

Examples of medical images include CT images, X-ray images, MRI images, fluorescence angiography images, OCT images, histological images, ultrasound images, fundus images and/or others.

The at least one received image can be a CT image, MRI image, ultrasound image, OCT image and/or some other representation of an examination region of an examination object.

The at least one received image can also include representations of the examination region of different modalities, for example a CT image and an MRI image.

Preferably, the at least one received image is the result of a radiological examination. “Radiology” is the branch of medicine that is concerned with the use of electromagnetic rays and mechanical waves (including for instance ultrasound diagnostics) for diagnostic, therapeutic and/or scientific purposes. Besides X-rays, other ionizing radiation such as gamma radiation or electrons are also used. Imaging being a key application, other imaging methods such as sonography and magnetic resonance imaging (nuclear magnetic resonance imaging) are also counted as radiology, even though no ionizing radiation is used in these methods. The term “radiology” in the context of the present disclosure thus encompasses in particular the following examination methods: computed tomography, magnetic resonance imaging, sonography.

In one embodiment of the present disclosure, the radiological examination is a magnetic resonance imaging examination.

In a further embodiment, the radiological examination is a computed tomography examination.

In a further embodiment, the radiological examination is an ultrasound examination.

In radiological examinations, contrast agents are commonly used for contrast enhancement.

“Contrast agents” are substances or mixtures of substances that improve the depiction of structures and functions of the body in radiological examinations.

In computed tomography, iodine-containing solutions are normally used as contrast agents. In magnetic resonance imaging (MRI), superparamagnetic substances (for example iron oxide nanoparticles, superparamagnetic iron-platinum particles (SIPPs)) or paramagnetic substances (for example gadolinium chelates, manganese chelates, hafnium chelates) are normally used as contrast agents. In the case of sonography, liquids containing gas-filled microbubbles are normally administered intravenously. Examples of contrast agents can be found in the literature (see, for example, A. S. L. Jascinth et al.: Contrast Agents in computed tomography: A Review, Journal of Applied Dental and Medical Sciences, 2016, Vol. 2, Issue 2, 143-149; H. Lusic et al.: X-ray-Computed Tomography Contrast Agents, Chem. Rev. 2013, 113, 3, 1641-1666; https://www.radiology.wisc.edu/wp-content/uploads/2017/10/contrast-agents-tutorial.pdf, M. R. Nough et al.: Radiographic and magnetic resonances contrast agents: Essentials and tips for safe practices, World J Radiol. 2017 Sep. 28; 9(9): 339-349; L. C. Abonyi et al.: Intravascular Contrast Media in Radiography: Historical Development & Review of Risk Factors for Adverse Reactions, South American Journal of Clinical Research, 2016, Vol. 3, Issue 1, 1-10; ACR Manual on Contrast Media, 2020, ISBN: 978-1-55903-012-0; A. Ignee et al.: Ultrasound contrast agents, Endosc Ultrasound. 2016 November-December; 5(6): 355-362).

MRI contrast agents exert their effect in an MRI examination by altering the relaxation times of structures that take up contrast agents. A distinction can be made between two groups of substances: paramagnetic and superparamagnetic substances. Both groups of substances have unpaired electrons that induce a magnetic field around the individual atoms or molecules. Superparamagnetic contrast agents result in a predominant shortening of T2, whereas paramagnetic contrast agents mainly result in a shortening of T1. The effect of said contrast agents is indirect, since the contrast agent does not itself emit a signal, but instead merely influences the intensity of signals in its vicinity. An example of a superparamagnetic contrast agent is iron oxide nanoparticles (SPIO, superparamagnetic iron oxide). Examples of paramagnetic contrast agents are gadolinium chelates such as gadopentetate dimeglumine (trade name: Magnevist® and others), gadoteric acid (Dotarem®, Dotagita®, Cyclolux®), gadodiamide (Omniscan®), gadoteridol (ProHance®), gadobutrol (Gadovist®), gadopiclenol (Elucirem, Vueway) and gadoxetic acid (Primovist®/Eovist®).

In one embodiment, the radiological examination is an MRI examination in which an MRI contrast agent is used.

In a further embodiment, the radiological examination is a CT examination in which a CT contrast agent is used.

In a further embodiment, the radiological examination is a CT examination in which an MRI contrast agent is used.

In one embodiment of the present disclosure, the contrast agent is an agent that includes gadolinium(III) 2-[4,7,10-tris(carboxymethyl)-1,4,7,10-tetrazacyclododec-1-yl]acetic acid (also referred to as gadolinium-DOTA or gadoteric acid).

In a further embodiment, the contrast agent is an agent that includes gadolinium(III) ethoxybenzyldiethylenetriaminepentaacetic acid (Gd-EOB-DTPA); preferably, the contrast agent includes the disodium salt of gadolinium(III) ethoxybenzyldiethylenetriaminepentaacetic acid (also referred to as gadoxetic acid).

In one embodiment of the present disclosure, the contrast agent is an agent that includes gadolinium(III) 2-[3,9-bis[1-carboxylato-4-(2,3-dihydroxypropylamino)-4-oxobutyl]-3,6,9,15-tetrazabicyclo[9.3.1]pentadeca-1(15),11,13-trien-6-yl]-5-(2,3-dihydroxypropylamino)-5-oxopentanoate (also referred to as gadopiclenol) (see for example WO 2007/042504 and WO 2020/030618 and/or WO 2022/013454).

In one embodiment of the present disclosure, the contrast agent is an agent that includes dihydrogen [(±)-4-carboxy-5,8,11-tris(carboxymethyl)-1-phenyl-2-oxa-5,8,11-triazatridecan-13-oato(5-)]gadolinate(2-) (also referred to as gadobenic acid).

In one embodiment of the present disclosure, the contrast agent is an agent that includes tetragadolinium [4,10-bis(carboxylatomethyl)-7-{3,6,12,15-tetraoxo-16-[4,7,10-tris-(carboxylatomethyl)-1,4,7,10-tetraazacyclododecan-1-yl]-9,9-bis({[({2-[4,7,10-tris-(carboxylatomethyl)-1,4,7,10-tetraazacyclododecan-1-yl]propanoyl}amino)acetyl]amino}methyl)-4,7,11,14-tetraazaheptadecan-2-yl}-1,4,7,10-tetraazacyclododecan-1-yl]acetate (also referred to as gadoquatrane) (see for example J. Lohrke et al.: Preclinical Profile of Gadoquatrane: A Novel Tetrameric, Macrocyclic High Relaxivity Gadolinium-Based Contrast Agent. Invest Radiol., 2022, 1, 57(10): 629-638; WO 2016193190).

In one embodiment of the present disclosure, the contrast agent is an agent that includes a Gd³⁺ complex of a compound of the formula (I)

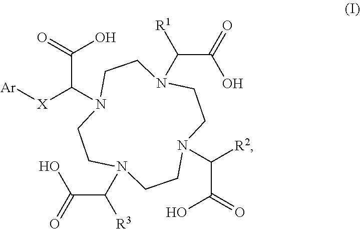

where
Ar is a group selected from

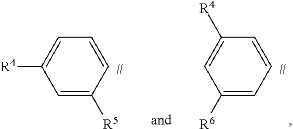

where # is the linkage to X,
X is a group selected from
CH₂, (CH₂)₂, (CH₂)₃, (CH₂)₄ and *—(CH₂)₂O—CH₂—^{#},
where * is the linkage to Ar and # is the linkage to the acetic acid residue,
R¹, R² and R³ are each independently a hydrogen atom or a group selected from C₁-C₃ alkyl, —CH₂OH, —(CH₂)₂OH and —CH₂OCH₃,
R⁴ is a group selected from C₂-C₄ alkoxy, (H₃C—CH₂)—O—(CH₂)₂—O—, (H₃C—CH₂)—O—(CH₂)₂—O—(CH₂)₂—O— and (H₃C—CH₂)—O—(CH₂)₂—O—(CH₂)₂—O—(CH₂)₂—O—,
R⁵ is a hydrogen atom,
and
R⁶ is a hydrogen atom,
or a stereoisomer, tautomer, hydrate, solvate or salt thereof, or a mixture thereof.

In one embodiment of the present disclosure, the contrast agent is an agent that includes a Gd³⁺ complex of a compound of the formula (II)

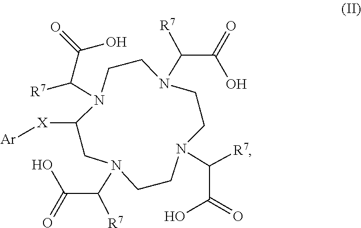

where
Ar is a group selected from

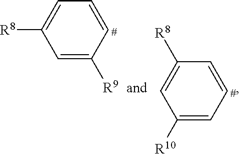

where # is the linkage to X,
X is a group selected from CH₂, (CH₂)₂, (CH₂)₃, (CH₂)₄ and *—(CH₂)₂—O—CH₂#, where * is the linkage to Ar and # is the linkage to the acetic acid residue,
R⁷ is a hydrogen atom or a group selected from C₁-C₃ alkyl, —CH₂OH, —(CH₂)₂OH and —CH₂OCH₃;
R⁸ is a group selected from
C₂-C₄ alkoxy, (H₃C—CH₂O)—(CH₂)₂—O—, (H₃C—CH₂O)—(CH₂)₂—O—(CH₂)₂—O— and (H₃C—CH₂O)—(CH₂)₂—O—(CH₂)₂—O—(CH₂)₂—O—;
R⁹ and R¹⁰ are each independently a hydrogen atom;
or a stereoisomer, tautomer, hydrate, solvate or salt thereof, or a mixture thereof.

The term “C₁-C₃ alkyl” denotes a linear or branched, saturated monovalent hydrocarbon group having 1, 2 or 3 carbon atoms, for example methyl, ethyl, n-propyl or isopropyl. The term “C₂-C₄ alkyl” denotes a linear or branched, saturated monovalent hydrocarbon group having 2, 3 or 4 carbon atoms.

The term “C₂-C₄ alkoxy” denotes a linear or branched, saturated monovalent group of the formula (C₂-C₄ alkyl)-O—, in which the term “C₂-C₄ alkyl” is as defined above, for example a methoxy, ethoxy, n-propoxy or isopropoxy group.

In one embodiment of the present disclosure, the contrast agent is an agent that includes gadolinium 2,2′,2″-(10-{1-carboxy-2-[2-(4-ethoxyphenyl)ethoxy]ethyl}-1,4,7,10-tetraazacyclododecane-1,4,7-triyl)triacetate (see for example WO 2022/194777, example 1).

In one embodiment of the present disclosure, the contrast agent is an agent that includes gadolinium 2,2′,2″-{10-[1-carboxy-2-{4-[2-(2-ethoxyethoxy)ethoxy]phenyl}ethyl]-1,4,7,10-tetraazacyclododecane-1,4,7-triyl}triacetate (see for example WO 2022/194777, example 2).

In one embodiment of the present disclosure, the contrast agent is an agent that includes gadolinium 2,2′,2″-{10-[(1R)-1-carboxy-2-{4-[2-(2-ethoxyethoxy)ethoxy]phenyl}ethyl]-1,4,7,10-tetraazacyclododecane-1,4,7-triyl}triacetate (see for example WO 2022/194777, example 4).

In one embodiment of the present disclosure, the contrast agent is an agent that includes gadolinium (2S,2'S,2″S)-2,2′,2″-{10-[(1S)-1-carboxy-4-{4-[2-(2-ethoxyethoxy)ethoxy]phenyl}butyl]-1,4,7,10-tetraazacyclododecane-1,4,7-triyl}tris(3-hydroxypropanoate) (see for example WO 2022/194777, example 15).

In one embodiment of the present disclosure, the contrast agent is an agent that includes gadolinium 2,2′,2″-{10-[(1S)-4-(4-butoxyphenyl)-1-carboxybutyl]-1,4,7,10-tetraazacyclododecane-1,4,7-triyl}triacetate (see for example WO 2022/194777, example 31).

In one embodiment of the present disclosure, the contrast agent is an agent that includes gadolinium-2,2′,2″-{(2S)-10-(carboxymethyl)-2-[4-(2-ethoxyethoxy)benzyl]-1,4,7,10-tetraazacyclododecane-1,4,7-triyl}triacetate.

In one embodiment of the present disclosure, the contrast agent is an agent that includes gadolinium 2,2′,2″-[10-(carboxymethyl)-2-(4-ethoxybenzyl)-1,4,7,10-tetraazacyclododecane-1,4,7-triyl]triacetate.

In one embodiment of the present disclosure, the contrast agent is an agent that includes gadolinium(III) 5,8-bis(carboxylatomethyl)-2-[2-(methylamino)-2-oxoethyl]-10-oxo-2,5,8,11-tetraazadodecane-1-carboxylate hydrate (also referred to as gadodiamide).

In one embodiment of the present disclosure, the contrast agent is an agent that includes gadolinium(III) 2-[4-(2-hydroxypropyl)-7,10-bis(2-oxido-2-oxoethyl)-1,4,7,10-tetrazacyclododec-1-yl]acetate (also referred to as gadoteridol).

In one embodiment of the present disclosure, the contrast agent is an agent that includes gadolinium(III) 2,2′,2″-(10-((2R,3S)-1,3,4-trihydroxybutan-2-yl)-1,4,7,10-tetraazacyclododecane-1,4,7-triyl)triacetate (also referred to as gadobutrol or Gd-DO3A-butrol).

The at least one received image can also include representations of the examination region that were generated under different measurement conditions, for example a T1-weighted MRI image and/or a T2-weighted MRI image and/or a diffusion-weighted MRI image and/or some other MRI image and/or one or more dual-energy CT images and/or one or more spectral CT images.

The at least one received image can also include multiple radiological images that were generated after administration of different amounts of a contrast agent and/or after administration of different contrast agents, for example a native radiological image and/or a radiological image after administration of a first amount of a contrast agent and/or one or more radiological images after administration of a second contrast agent and/or a virtual non-contrast representation (VNC representation).

The at least one received image can also include multiple radiological images that were generated at different times before and/or after the administration of one or more contrast agents and/or that represent the examination region in different phases and/or states.

Each received image comprises a multiplicity of image elements. Each image element of the multiplicity of image elements represents a sub-region of the examination region of the examination object. The terms “multiplicity of image elements” and “plurality of image elements” as used herein may mean at least 1000, or at least 10,000, or at least 100,000, or more than 100,000. It is conceivable that a received image comprises one or more image elements that do not represent the examination region of the examination object, but some other region such as an adjoining and/or surrounding region.

A plurality of different modifications is generated from the at least one received image. The term “plurality of different modifications” as used herein refers to at least two, preferably at least five and even more preferably at least ten different modifications.

The term “different” as used herein may suggest that the plurality of modifications does not include any modifications that are identical. In other words, two modifications randomly selected from the plurality of different modifications are not identical, but are different from each other.

The term “modification of the at least one image” is understood to mean a variant of the at least one image and/or an altered image and/or a variation of the at least one image. A modification of the at least one image is generated on the basis of the at least one image.

A modification of an image is a “image” in the context of the present disclosure.

The modification of the at least one image is done, for example, by image augmentation.

Image augmentation is a technique that can be used when training machine-learning models, especially when there are insufficient training data. The training data set can be enlarged by altering the original data in various ways. The quality (e.g., the accuracy of prediction) of the machine-learning model can be increased by the enlarged training data set (see, for example, S. Yang et al.: Image Data Augmentation for Deep Learning: A Survey, arXiv:2204.08610v1).

In the present case, the purpose of image augmentation is not to enlarge a training data set for the generative model, but to generate different input data for the generative model during the inference of the generative model. The different input data can be fed to the generative model separately from each other and, on the basis of each set of different input data, the generative model generates a synthetic image as output data. By comparing the generated synthetic images, it is possible to determine how robust the generative model is in relation to altered input data. By comparing the generated synthetic images, it is possible to determine at least one confidence value, as described in this disclosure.

There are a multitude of techniques for image augmentation. Some examples are listed below.

From the at least one image, different modifications can be generated, for example, by one or more geometric transformations. Examples of geometric transformations include rigid transformations, non-rigid transformations, affine transformations and non-affine transformations.

A rigid transformation does not alter the size or shape of the image. Examples of rigid transformations include reflection, rotation and translation.

A non-rigid transformation can alter the size or shape, or both the size and shape, of the image. Examples of non-rigid transformations include dilation and shearing.

An affine transformation is a geometric transformation that preserves lines and parallelism, but not necessarily distances and angles. Examples of affine transformations include translation, scaling, homothety, similarity, reflection, rotation, shear mapping and compositions thereof in any combination and sequence.

Modifications of the at least one received image can be generated, for example, by variation of the color values. The color values of a predefined number of image elements can be reduced or increased by a predefined value, the color values of color channels can be interchanged, color values can be converted into grey values, and image elements can be masked. Further changes of color values are conceivable.

Modifications of the at least one received image can be generated by replacing the color values of a predefined number of image elements with noise and/or by setting the color values to zero and/or some other value.

Modifications of the at least one received image can be generated by setting the color values of a predefined number of contiguous image elements to zero and/or some other value.

Modifications of the at least one received image can be generated by varying the sharpness and/or contrast of the at least one image.

If more than one image is received, modifications can be generated by generation of partial blends; for example, the color values of a predefined number of image elements of a received image can be replaced by color values of corresponding image elements of another received image.

Combinations of multiple image augmentation techniques are possible. The image augmentation techniques mentioned here and further image augmentation techniques are described in numerous publications (see, for example, M. Xu et al.: A Comprehensive Survey of Image Augmentation Techniques for Deep Learning, arXiv:2205.01491v2; S. Yang et al.: Image Data Augmentation for Deep Learning: A Survey, arXiv:2204.08610v1; D. Itzkovich et al.: Using Augmentation to Improve the Robustness to Rotation of Deep Learning Segmentation in Robotic-Assisted Surgical Data, 2019 International Conference on Robotics and Automation (ICRA), Montreal, QC, Canada, 2019, pp. 5068-5075; E. Castro et al.: Elastic deformations for data augmentation in breast cancer mass detection, 2018 IEEE EMBS International Conference on Biomedical Health Informatics (BHI), pp. 230-234, 2018; Y.-J. Cha et al.: Autonomous Structural Visual Inspection Using Region-Based Deep Learning for Detecting Multiple Damage Types, Computer-Aided Civil and Infrastructure Engineering, 00, 1-17. 10.1111/mice.12334; S. Wang et al.: Multiple Sclerosis Identification by 14-Layer Convolutional Neural Network With Batch Normalization, Dropout, and Stochastic Pooling, Frontiers in Neuroscience, 12. 818. 10.3389/fnins.2018.00818; Z. Wang et al.: CNN Training with Twenty Samples for Crack Detection via Data Augmentation, Sensors 2020, 20, 4849; B. Hu et al.: A Preliminary Study on Data Augmentation of Deep Learning for Image Classification, Computer Vision and Pattern Recognition; Machine Learning (cs.LG); Image and Video Processing (eess.IV), arXiv:1906.11887; R. Takahashi et al.: Data Augmentation using Random Image Cropping and Patching for Deep CNNs, Journal of Latex Class Files, Vol. 14, No. 8, 2015, arXiv:1811.09030; T. DeVries and G. W. Taylor: Improved Regularization of Convolutional Neural Networks with Cutout, arXiv:1708.04552, 2017.; Z. Zhong et al.: Random Erasing Data Augmentation, arXiv:1708.04896, 2017).

Each modification is fed to a generative model in a next step.

The generative model is configured to generate, on the basis of the at least one received image (and/or a modification thereof) of the examination region of the examination object, a synthetic image of the examination region of the examination object.

The generative model can be a trained machine-learning model. A “machine learning model” can be understood as meaning a computer-implemented data processing architecture. Such a model is able to receive input data and to supply output data on the basis of said input data and model parameters. Such a model is able to learn a relationship between the input data and the output data through training. During training, the model parameters can be adjusted so as to supply a desired output for a particular input.

During the training of such a model, the model is presented with training data from which it can learn. The trained machine-learning model is the result of the training process. Besides input data, the training data include the correct output data (target data) that are to be generated by the model on the basis of the input data. During training, patterns that map the input data onto the target data are identified.

In the training process, the input data of the training data are input into the model, and the model generates output data. The output data are compared with the target data. Model parameters are altered so as to reduce the differences between the output data and the target data to a (defined) minimum. The modification of model parameters in order to reduce the differences can be done using an optimization process such as a gradient process.

The differences can be quantified with the aid of a loss function. A loss function of this kind can be used to calculate a loss for a given set of output data and target data. The aim of the training process may consist of altering (adjusting) the parameters of the machine-learning model so as to reduce the loss for all pairs of the training data set to a (defined) minimum.

For example, if the output data and the target data are numerical values, the loss function can be the absolute difference between these values. In this case, a high absolute loss value can mean that one or more model parameters needs to be changed to a substantial degree.

For example, for output data in the form of vectors, difference metrics between vectors such as the mean square error, a cosine distance, a norm of the difference vector such as a Euclidean distance, a Chebyshev distance, an Lp norm of a difference vector, a weighted norm or another type of difference metric of two vectors can be chosen as the loss function.

In the case of higher-dimensional outputs, such as two-dimensional, three-dimensional or higher-dimensional outputs, an element-by-element difference metric can for example be used.

Alternatively or in addition, the output data may be transformed into for example a one-dimensional vector before calculation of a loss value.

FIG. 5 shows in schematic form an example of training a machine-learning model and is described in greater detail below.

The generative model can be a machine-learning model, as described for example in one of the following publications: WO 2019/074938 A1, WO 2022/253687 A1, WO 2022/207443 A1, WO 2022/223383 A1, WO 2022/7184297 A1, WO 2022/179896 A2, WO 2021/069338 A1, EP 22209510.1, EP 23159288.2, WO 2023/161041 A1, WO 2023/135056 A1, WO 2023/237742 A1, CN 110852993A, CN 110853738A, U.S. 2021150671A1, arXiv:2303.15938v1, doi:10.1093/jrr/rrz030.

The generative model can comprise one or more algorithms specifying how the synthetic image can be generated on the basis of the at least one received image. The at least one received image is usually fed to the generative model and, on the basis of the at least one image fed, model parameters and optionally further input data, the model generates the synthetic image (see, for example, WO 2019/074938 A1, WO 2022/184297 A1, WO 2021/052896 A1, WO 2023/161041 A1).

The at least one received image can comprise, for example, a radiological image of the examination region without contrast agent and/or with a lower amount of contrast agent than the standard amount of the contrast agent and the synthetic image can be a synthetic radiological image of the examination region after the administration of the standard amount of contrast agent (as described, for example, in WO 2019/074938 A1, WO 2022/184297 A1 or WO 2023/237742 A1). The “standard amount” is normally the amount recommended by the manufacturer and/or distributor of the contrast agent and/or the amount approved by a regulatory authority and/or the amount specified in a package leaflet for the contrast agent. In such a case, the generative model is thus configured to generate, on the basis of at least one radiological image of the examination region before and/or after administration of a first amount of a contrast agent, a synthetic radiological image after the administration of a second amount of the contrast agent, the second amount being preferably greater than the first amount (as described, for example, in WO 2019/074938 A1, WO 2022/184297 A1 or WO 2023/237742 A1). The at least one received radiological image can be, for example, an MRI image, and the synthetic radiological image a synthetic MRI image.

The at least one received image can also comprise a CT image before and/or after the administration of a first amount of an MRI contrast agent and the synthetic image can be a synthetic CT image after the administration of a second amount of an MRI contrast agent, the second amount being preferably greater than the first amount and preferably greater than the standard amount of the MRI contrast agent for MRI examinations (as described, for example, in WO 2023/161041 A1).

The at least one received image can comprise, for example, one or more radiological images of the examination region in a first period of time before and/or after the administration of a contrast agent and the synthetic image can be a synthetic radiological image of the examination region in a second period of time after the administration of the contrast agent (as described, for example, in WO 2021/052896 A1). The generative model can thus be configured to generate, on the basis of at least one radiological image of the examination region in a first period of time before and/or after the administration of a contrast agent, a synthetic radiological image of the examination region in a second period of time after the administration of the contrast agent, the second period of time preferably chronologically following the first period of time (as described, for example, in WO 2021/052896 A1).

However, in contrast to the methods described in the above-cited publications, the generative model in the case of the present disclosure is not (just) fed the at least one received image; the generative model is (also) fed modifications of the at least one received image.

If the generative model is configured to generate a synthetic image on the basis of a single received image, modifications are generated from the received image and each modification is fed separately to the generative model. On the basis of each fed modification, the generative model then respectively generates a synthetic image. In addition to each modification of the received image, the generative model can also be fed the received image itself, on the basis of which the generative model then generates a further synthetic image. Any received image itself can thus also be a modification that is fed to the generative model.

If the generative model is configured to generate a synthetic image on the basis of two received images (a first image and a second image), then a plurality of modifications is generated from each image (from the first image and from the second image). The generative model is then fed the modifications of the first image and the second image, specifically one modification of the first image and one modification of the second image at a time (i.e., in the form of pairs). From each pair of one modification of the first image and one modification of the second image, the generative model generates a synthetic image. In addition to pairs of modifications of the first and the second image, the generative model can also be fed the first and the second image, on the basis of which the generative model then generates a further synthetic image.

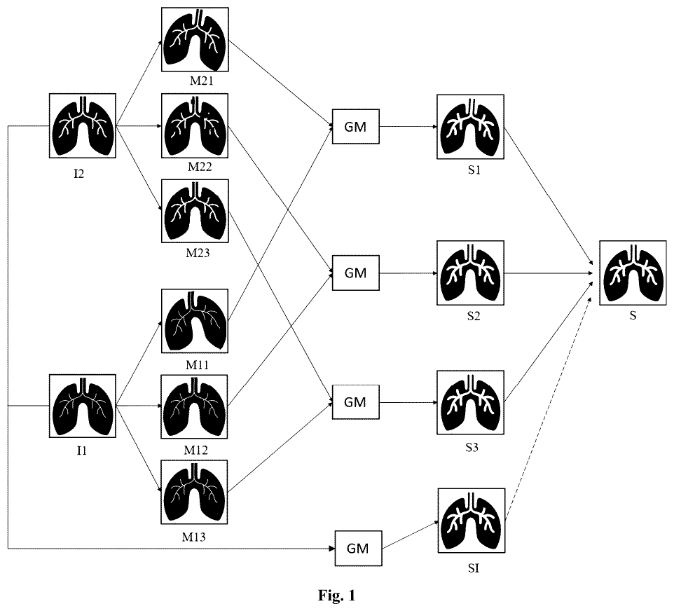

If the generative model is configured to generate a synthetic image on the basis of m received images (where m is a positive integer), what is usually generated from each of the m received images is a number p of modifications, altogether m×p modifications, where p is a positive integer. The generative model can then be fed the m×p modifications of the m received images, specifically in sets of a respective modification of each of the m images (i.e. there are usually p sets and each set usually comprises m modifications). The generative model generates a synthetic image from each set. What are thus usually generated are p synthetic images. If a synthetic image is also generated on the basis of the m received images, a number (p+1) of synthetic images is usually generated. Yet further synthetic images can be generated, as described for example in relation to FIG. 1.

Each of the generated synthetic images can be output (e.g., displayed on a monitor and/or printed on a printer), stored in a data memory and/or transmitted to a separate computer system, for example via a network.

The generated synthetic images can be combined to form a single synthetic image in a further step. Such a synthetic image generated by combining synthetic images is also referred to as a combined synthetic image in this disclosure. The combined synthetic image can be, for example, an average image of all the generated synthetic images.

The combined synthetic image can be generated on the basis of corresponding image elements of the generated synthetic images.

Each received image comprises a multiplicity of image elements. Each image element of the multiplicity of image elements represents a sub-region of the examination region of the examination object.

Each modification of a received image likewise also comprises a multiplicity of image elements. Each image element of a modification usually represents a sub-region of the examination region of the examination object. However, it is also possible for a modification to have image elements that do not represent a sub-region of an examination region. Such image elements can be, for example, the result of padding applied during image augmentation. However, most of the image elements of each modification represent a sub-region of the examination region. The number of image elements of a modification is usually equal to the number of image elements of the received image from which the modification was generated; it is usually at least of the same order of magnitude.

Each synthetic image of the examination region of the examination object likewise also comprises a multiplicity of image elements. Each image element of a synthetic image usually represents a sub-region of the examination region of the examination object.

There are thus a multiplicity of sub-regions of the examination region of the examination object that are represented by an image element (or multiple image elements) of the at least one received image and by an image element (or multiple image elements) of each modification and by an image element (or multiple image elements) of the synthetic image. Preferably, all sub-regions of the examination region are represented by an image element (or multiple image elements) of the at least one received image and by an image element (or multiple image elements) of each modification and by an image element (or multiple image elements) of the synthetic image.

Image elements representing the same sub-region of the examination region are referred to as mutually corresponding image elements, or corresponding image elements for short, in this disclosure. Corresponding image elements can be, for example, the image elements having the same coordinates if the image (and/or the modification) is a raster graphic.

For each k-tuple of corresponding image elements of the generated synthetic images, the color values are determined. Here, k indicates the number of mutually corresponding image elements.

From the determined color values, a mean (e.g., arithmetic mean, geometric mean, root mean square and/or some other mean) can be calculated. The mean of the color values for a tuple of corresponding image elements can be set as the color value of the corresponding image element of the combined synthetic image.

In the case of multiple color values (e.g., three color values as in the case of the RGB color model), a mean can be formed for each color channel. The respective mean can then be set as the color value of the corresponding color channel of the corresponding image element of the combined synthetic image.

It is also conceivable to determine a maximum or minimum color value instead of a mean for corresponding image elements and to compose the combined synthetic image from the image elements having the respective maximum or minimum color values. Instead of maxima/minima, other statistical values can also be determined and used to generate the combined synthetic image.

Further possibilities of combining the individual synthetic images to form a combined synthetic image are conceivable. For example, a machine-learning model (e.g., an artificial neural network) can be trained to generate the combined synthetic image from the synthetic images of the plurality of synthetic images according to specified factors. If training data are available that comprise not only synthetic images as input data, but also images which can be used as target data, the machine-learning model can be trained in a supervised learning method to combine synthetic images of a plurality of synthetic images. For example, attention mechanisms (see, for example, arXiv:2203.14263) can be used in which, for example, the individual synthetic images of the plurality of synthetic images are assigned different weights when combining them to form the combined synthetic image.

It is also possible that the method for generating a combined synthetic image is not the same for each tuple of corresponding image elements. It is possible to use different methods for generating the combined synthetic image for different sub-regions of the examination object. For example, it is possible that image elements representing a specific tissue and/or organ and/or lesion use a different method for combining the color values of the image elements than image elements representing another tissue and/or another organ and/or another sub-region. Sub-regions for which there are different rules for combining corresponding image elements can be identified, for example, by means of segmentation.

The term “segmentation” refers to the process of dividing an image into multiple segments, which are also referred to as image segments, image regions or image objects. Segmentation is generally used to locate objects and boundaries (lines, curves, etc.) in images. In a segmented image, the objects located can be separated from the background, visually highlighted (e.g., in color), measured, counted and/or quantified in some other way. In segmentation, each image element of an image is assigned a label (e.g., a number), and so image elements having the same label have certain features in common, for example represent the same tissue (e.g., bone tissue or adipose tissue or healthy tissue or diseased tissue (e.g., tumour tissue) or muscle tissue and/or the like) and/or the same organ. For corresponding image elements having a specific label, a specific calculation rule can then be used to combine their color values to generate a combined synthetic image; for corresponding image elements having a different (specific) label, a different (specific) calculation rule can be used to combine their color values.

It is also possible that more than one combined synthetic image is generated, for example two or three or four or more than four. For example, a first combined synthetic image having the respective maxima of the color values can be generated and a second combined synthetic image having the respective minima of the color values can be generated. A third combined synthetic image having means (e.g., arithmetically averaged values) of the color values can also be generated.

The combined synthetic image can be output (e.g., displayed on a monitor and/or output on a printer) and/or stored in a data memory and/or transmitted to a separate computer system, for example via a network connection.

It is also possible that no combined synthetic image is generated and/or output. It is possible that the below-described analysis of corresponding image elements of synthetic images reveals that a combined synthetic image has low trustworthiness. For example, a determined confidence value positively correlating with trustworthiness may be lower than a predefined limit value. It may be that the determined confidence value and hence the trustworthiness is so low that a diagnosis should not be made and/or therapeutic measures should not be initiated on the basis of the combined synthetic image. In such a case, it may be that a combined synthetic image is worthless or even misleading and hence dangerous. The generation and/or output of such a combined synthetic image having low trustworthiness can then be dispensed with. A warning can be output to draw a user's attention to the fact that a synthetic image having low trustworthiness has been generated by means of the generative model on the basis of the received images.

It is also possible that, instead of the combined synthetic image or in addition to the combined synthetic image, what is generated and output is a synthetic image which has been generated by means of the generative model on the basis of the at least one received image (and not on the basis of one or more modifications of the at least one received image). It is conceivable that the synthetic images generated on the basis of the modifications are generated for the purpose of determining a confidence value (or multiple confidence values). The confidence value described in this disclosure can thus be a confidence value for a combined synthetic image generated on the basis of modifications of the at least one received image, and/or it can be a confidence value for a synthetic image generated on the basis of the unmodified at least one received image.

The determination of the at least one confidence value will be described in greater detail below.

The at least one confidence value can be a value indicating the extent to which a synthetic image can be trusted (e.g., the combined synthetic image and/or a synthetic image generated on the basis of the m received unmodified images). The confidence value can positively correlate with the trustworthiness of the synthetic image, i.e., if the confidence value is low, trustworthiness is also low, and if the confidence value is high, trustworthiness is also high. However, it is also possible for the confidence value to negatively correlate with trustworthiness, i.e., if the confidence value is low, trustworthiness is high, and if the confidence value is high, trustworthiness is low. In the case of negative correlation, another term that can be used instead of confidence value is uncertainty value: if the uncertainty value is high, then the synthetic image gives rise to a high degree of uncertainty; it is possible that the synthetic image has one or more artifacts; it is possible that structures and/or morphologies and/or textures in the synthetic image have no correspondence in reality, i.e. that structures and/or morphologies and/or textures in the synthetic image cannot be attributed to real structures and/or real morphologies and/or real textures in the examination region. By contrast, a low uncertainty value indicates that the synthetic image has a low degree of uncertainty; features in the synthetic image have a correspondence in reality; the synthetic image can be trusted; a medical diagnosis can be made on the basis of the synthetic image and/or a medical therapy can be initiated on the basis of the synthetic image.

A confidence value positively correlating with trustworthiness can in principle also be converted into a confidence value negatively correlating with trustworthiness (into an uncertainty value), for example by forming the reciprocal (multiplicative inverse). Conversely, a confidence value negatively correlating with trustworthiness (an uncertainty value) can correspondingly also be converted into a confidence value positively correlating with trustworthiness.

The at least one confidence value can be determined on the basis of corresponding image elements of synthetic images.

For each k-tuple of corresponding image elements of the generated synthetic images, the color values are determined. Here, k indicates the number of mutually corresponding image elements.

The more the color values of corresponding image elements in the synthetic images differ, the greater the impact of the modification(s) forming the basis of the generation of a synthetic image. If, however, the modification(s) forming the basis of a synthetic image has/have a great impact, then the synthetic image gives rise to a certain degree of uncertainty; trustworthiness is lower, the greater the differences caused by the different modifications in the color values of corresponding image elements.

Therefore, the extent to which color values of corresponding image elements differ can be used as a measure of trustworthiness/uncertainty: the greater the difference between color values of corresponding image elements, the lower the trustworthiness and the higher the uncertainty; the lower the difference between color values of corresponding image elements, the lower the uncertainty and the higher the trustworthiness.

Trustworthiness/uncertainty can thus be determined for each tuple of corresponding image elements of synthetic images of the plurality of synthetic images and then represents the trustworthiness/uncertainty (i) of each synthetic image of the plurality of synthetic images, (ii) of all the synthetic images of the plurality of synthetic images, (iii) of the combined synthetic image, and (iv) of the synthetic image generated on the basis of the at least one received unmodified image.

In other words, what can be determined for each individual image element of the combined synthetic image and/or of each synthetic image of the plurality of synthetic images and/or of the synthetic image generated on the basis of the at least one received unmodified image is a confidence value indicating the extent to which the color value of the image element can be trusted.

Such a confidence value can be, for example, the range of the color values of the tuple of corresponding image elements. The range is defined as the difference between the largest value and the smallest value of a variable. Thus a maximum color value and a minimum color value can be determined for each tuple of corresponding image elements and the difference between the maximum and the minimum color value can be formed. The result is the range of the color values of the tuple of corresponding image elements that can be used as a confidence value.

If there is more than one color value (e.g., three color values, as in the case of images, the color values of which are specified according to the RGB color model), a maximum and a minimum color value can be determined for each color channel and the difference can be formed for each color channel. Three ranges are formed. For each color channel, the respective range can be used as a separate confidence value; however, it is also possible to combine the ranges of the color channels to form a single value; it is possible to use the maximum range as a confidence value; it is possible to use a mean (e.g., arithmetic mean, geometric mean, root mean square or some other mean) of the ranges as a confidence value; it is possible to use the length of the vector specified by the ranges in a three-dimensional space (or a higher-dimensional space when using more than three color channels) as a confidence value; further possibilities are conceivable.

A confidence value for a tuple of corresponding image elements can also be the variance and/or standard deviation of the color values of the corresponding image elements. The variance is defined as the average squared deviation of a variable from its expected value; the standard deviation is defined as the square root of the variance.

A confidence value can also be another measure of dispersion, such as the sum of squared deviations, the coefficient of variation, the mean absolute deviation, a quantile range, an interquantile range, the mean absolute deviation from the median, the median absolute deviation and/or the geometric standard deviation. It is also possible that there is more than one confidence value for a tuple of corresponding image elements.

It is also possible that the method for calculating a confidence value is not the same for each tuple of corresponding image elements. It is possible to use different methods for calculating a confidence value for different sub-regions of the examination object. For example, it is possible that image elements representing a specific tissue and/or organ and/or lesion use a different method for calculating a confidence value than image elements representing another tissue and/or another organ and/or another sub-region. Sub-regions for which there are different calculation rules for confidence values can be identified, for example, by means of segmentation.

In segmentation, each image element of an image can be assigned a label (e.g., a number), and so image elements having the same label have certain features in common, for example represent the same tissue (e.g., bone tissue or adipose tissue or healthy tissue or diseased tissue (e.g., tumour tissue) or muscle tissue and/or the like) and/or the same organ. For corresponding image elements having a specific label, a specific calculation rule can then be used to calculate a confidence value; for corresponding image elements having a different (specific) label, a different (specific) calculation rule can be used to calculate a confidence value.

The confidence values determined for tuples of corresponding image elements can be output (e.g., displayed on a monitor or printed on a printer), stored in a data memory and/or transmitted to a separate computer system, for example via a network.

The confidence values determined for tuples of corresponding image elements can also be displayed pictorially.

In addition to the combined synthetic image and/or the synthetic image generated on the basis of the at least one received unmodified image, a further representation of the examination region can thus be output (e.g., displayed on a monitor), indicating the trustworthiness for each image element. Such a representation is also referred to as confidence representation in this description. The confidence representation preferably has the same dimensions and size as the combined synthetic image and/or the image generated on the basis of the at least one received unmodified image; each image element of the combined synthetic image and/or the image generated on the basis of the at least one received unmodified image is preferably assigned an image element in the confidence representation.

Such a confidence representation can be used by a user (e.g., a doctor) to identify for each individual image element the extent to which the color value of the image element can be trusted. It is possible to completely or partly superimpose the confidence representation with the combined synthetic image and/or the image generated on the basis of the at least one received unmodified image. It is possible to configure the superimposition in such a way that it can be faded in and out by the user. The combined synthetic image and/or the synthetic image generated on the basis of the at least one received unmodified image can be displayed layer by layer, for example, by the user, as is customary for computed tomography representations, magnetic resonance imaging representations, and other three- or higher-dimensional representations. For each layer, the user can fade in the corresponding layer of the confidence representation in order to check whether image elements in the layer showing structures, morphologies and/or textures are trustworthy or uncertain. This allows the user to identify the level of the risk of the structures, morphologies and/or textures not being real properties of the examination, but artifacts.

For example, image elements having low trustworthiness (having a high degree of uncertainty) can be displayed brightly and/or with a signal color (e.g., red or orange or yellow), whereas image elements having high trustworthiness (having a low degree of uncertainty) can be displayed darkly or with a more inconspicuous or calming color (e.g., green or blue). It is also possible, in the case of a superimposition, to display those image elements for which the confidence value exceeds or falls short of a predefined limit value. If the confidence value correlates positively with trustworthiness, what can be displayed for example are those image elements of the confidence representation, the confidence value of which is below a predefined limit value; in such a case, a user (e.g., a doctor) is informed of those image elements that they should better not trust.

It is also possible to determine confidence values for sub-regions of the combined synthetic image and/or the image generated on the basis of the at least one received unmodified image (e.g., layers within the respective synthetic image) and/or for the entire combined synthetic image and/or the entire synthetic image generated on the basis of the at least one received unmodified image. Determination of such confidence values for sub-regions or entire images can be done on the basis of the confidence values of those image elements of which they are composed. For example, a confidence value of a layer can be determined by taking into account all the confidence values of those image elements that lie in said layer. However, it is also possible to also take into account adjacent image elements (e.g., image elements of the layer above and/or below the layer under consideration). A confidence value for a sub-region or the entire region can be determined, for example, by forming a mean (e.g., arithmetic mean, geometric mean, root mean square or some other mean). It is also possible to determine the maximum value (e.g., in the case of a confidence value correlating negatively with trustworthiness) or the minimum value (e.g., in the case of a confidence value correlating negatively with trustworthiness) of the confidence values of the image elements of a sub-region or the entire region and to use it as the confidence value of the sub-region or the entire region. Further ways of determining a confidence value for a sub-region or the entire region on the basis of the confidence values of individual image elements are conceivable.

Such a confidence value for a sub-region or the entire region can be likewise output (e.g., displayed on a monitor or output on a printer), stored in a data memory and/or transmitted to a separate computer system. It can also be displayed pictorially (e.g., in color), as described for the individual confidence values.

If a confidence value for a sub-region or the entire region that correlates positively with trustworthiness is lower than a predefined limit value, then it is possible that the corresponding sub-region or entire region should not be trusted. It is possible that such a sub-region or the corresponding entire region is not output at all (e.g., not displayed at all), as described above, or that it is displayed with a warning indicating that a user should be careful when interpreting the displayed data owing to the uncertainty of the displayed data.

It is also possible that the user of the computer system/computer program of the present disclosure is given the option, via a user interface, of navigating in the combined synthetic image to sub-regions having low trustworthiness. For example, the user can be shown the sub-regions having the lowest trustworthiness in a list (e.g., in the form of a list having a number q of sub-regions having the lowest confidence value correlating positively with trustworthiness, where q is a positive integer). By clicking on a list entry, the user can be shown the corresponding sub-region in the form of a synthetic image, the combined synthetic image, a confidence representation and/or a received image and/or a detail thereof.

The disclosure will be more particularly elucidated hereinbelow with reference to drawings, without any intention to restrict the disclosure to the features or combinations of features shown in the drawings. Statements made in relation to the embodiments shown in the drawings are intended to be generally applicable, i.e., they are intended to be applicable to other embodiments as well in an analogous manner and not intended to be limited to the embodiment shown.

FIG. 1 shows by way of example and in schematic form the generation of modifications of received images, the generation of a plurality of synthetic images on the basis of the modifications with the aid of a generative model, and the generation of a combined synthetic image on the basis of the plurality of synthetic images.

In the example shown in FIG. 1, two images are received: a first image I1 and a second image I2. The images I1 and I2 are medical images of an examination region of an examination object. The examination object is a human and the examination region includes the human lung.

A plurality of modifications is generated from each received image. In the example shown in FIG. 1, the three modifications M11, M12 and M13 are generated from the first image I1 and the three modifications M21, M22 and M23 are generated from the second image I2.

The modification M11 is generated by distortion of the first image I1.

The modification M12 is generated by row-by-row shifting of the image elements of the first image I1 by a random absolute value within predefined limits.

The modification M13 is generated by addition of noise to the first image I1.

The modification M21 is generated by rotation of the second image I2 about an axis perpendicular to the drawing plane by a predefined angle.

The modification M22 is generated by deletion of sub-regions of the second image I2.

The modification M23 is generated by reduction of the resolution of the second image I2.

The modifications M11, M12 and M13 are different from each other; different image augmentation techniques are applied to generate the three modifications M11, M12 and M13 from the first image I1.

The modifications M21, M22 and M23 are likewise different from each other; different image augmentation techniques are applied to generate the three modifications M21, M22 and M23 from the second image I2.

In the example shown in FIG. 1, all the image augmentation techniques are different.

However, it is possible that the same image augmentation techniques are used for different received images. For example, it is possible that the same image augmentation technique is used to generate the modification M11 from the first image I1 as is used to generate the modification M21, M22 or M23 from the second image. If the same image augmentation techniques are used for different received images, then the same image augmentation techniques are preferably used to generate modifications that are jointly fed to the generative model. In the example shown in FIG. 1, these would be the modifications M11 and M21, M12 and M22, and M13 and M23.

In the example shown in FIG. 1, the modifications are fed in pairs to a generative model GM. For better understanding, the generative model GM is shown four times in FIG. 1; however, it is the same model.

The generative model GM is configured to generate on the basis of two images a synthetic image.

The generative model GM is fed the modifications M11 and M21 together. The generative model GM generates on the basis of the modifications M11 and M21 a first synthetic image S1. The generative model GM is also fed the modifications M12 and M22 together. The generative model GM generates on the basis of the modifications M12 and M22 a second synthetic image S2. The generative model GM is also fed the modifications M13 and M23 together. The generative model GM generates on the basis of the modifications M13 and M23 a third synthetic image S3.

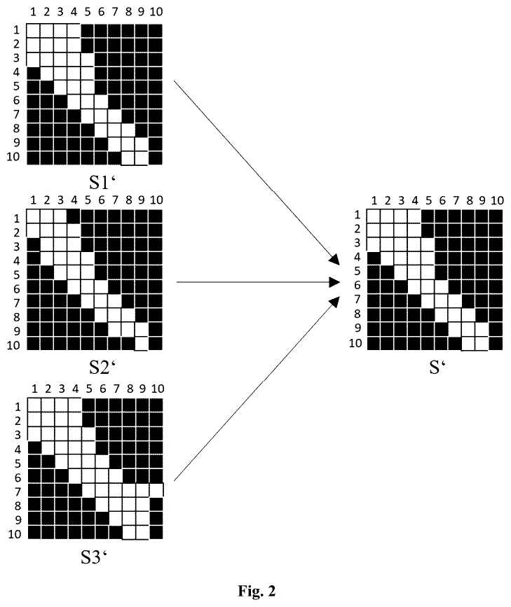

In the example shown in FIG. 1, the synthetic images S1, S2 and S3 are combined to form a combined synthetic image S. An example of such a combination is shown in schematic form in FIG. 2. The combined synthetic image S can be output (e.g., displayed on a monitor or printed on a printer), stored in a data memory and/or transmitted to a separate computer system.

It is also possible that no combined synthetic image is generated. It is possible that the synthetic images S1, S2 and S3 are generated to determine at least one confidence value.

In the example shown in FIG. 1, the first image I1 and the second image I2 are also jointly fed to the generative model GM. The generative model generates on the basis of these unmodified images a further synthetic image SI.

It is possible that the further synthetic image SI is output alongside the combined synthetic image S or instead of the combined synthetic image S.

It is possible that the further synthetic image SI can be included in the generation of the combined synthetic image (see the dashed arrow in FIG. 1); in such a case, the synthetic images S1, S2, S3 and SI are combined to form the combined synthetic image.

It is possible to generate further synthetic images. For example, a further synthetic image can be generated by feeding the first image I1 together with one of the modifications M21, M22 and M23 to the generative model GM. A further synthetic image can likewise be generated by feeding the generative model GM the second image I2 together with one of the modifications M11, M12 or M13. It is likewise possible that the modification M11 together with one of the modifications M22 or M23 is fed to the generative model GM. It is likewise possible that the modification M12 together with one of the modifications M21 or M23 is fed to the generative model GM. It is likewise possible that the modification M13 together with one of the modifications M21 or M22 is fed to the generative model GM.

Each further synthetic image that is generated can be included in the generation of the combined synthetic image.

Each further synthetic image that is generated can be used to determine the at least one confidence value.

FIG. 2 shows by way of example and in schematic form the combination of synthetic images to form a combined synthetic image.

Three synthetic images S1′, S2′ and S3′ are shown. The three synthetic images can be enlarged details of the synthetic images S1, S2 and S3 shown in FIG. 1.

Each of the three synthetic images S1′, S2′ and S3′ comprises a number of 10×10=100 image elements. The image elements are arranged in a grid; each row and column is assigned a numeral, thus allowing each image element to be clearly specified by its coordinates (row value, column value).

The synthetic images S1′, S2′ and S3′ are binary images, i.e. each image element is assigned either the color value “white” or the color value “black”.

The combined synthetic image S′ is generated by combination of the synthetic images S1′, S2′ and S3′. The combination is done on the basis of corresponding image elements. Corresponding image elements represent, in each case, the same sub-region of the examination region of the examination object. In the present example, the coordinates of corresponding image elements are identical. For example, the image element having the coordinates (1,1) of the synthetic image S1′ corresponds to the image element having the coordinates (1,1) of the synthetic image S2′ and to the image element having the coordinates (1,1) of the synthetic image S3′. The image elements having the coordinates (1,1) of the synthetic images S1′, S2′ and S3′ form a tuple of corresponding image elements. The number of mutually corresponding image elements is 3 (k=3) in each case; each of the 100 image elements of each synthetic image corresponds to two respective image elements of the other synthetic images.

For each tuple of corresponding image elements, the color values are determined and, on the basis of the determined color values, the color value of the corresponding image element of the combined synthetic image is determined.

In the present example, the synthetic images are combined according to the following rule to form the combined synthetic image: the color value of each image element of the combined synthetic image S′ corresponds to the color value of the majority of the color values of the corresponding image elements of the synthetic images S1′, S2′ and S3′.

For example, the color value for the image element having the coordinates (1,1) of the synthetic image S1′ is “white”. The color value for the corresponding image element having the coordinates (1,1) of the synthetic image S2′ is also “white”. The color value for the corresponding image element having the coordinates (1,1) of the synthetic image S3′ is also “white”. The majority of the corresponding image elements (namely all the image elements) have the color value “white”. Accordingly, the color value of the image element having the coordinates (1,1) of the combined synthetic image is also set to “white”.

For example, the color value for the image element having the coordinates (1,4) of the synthetic image S1′ is “white”. The color value for the corresponding image element having the coordinates (1,4) of the synthetic image S2′ is “black”. The color value for the corresponding image element having the coordinates (1,4) of the synthetic image S3′ is “white”. The majority of the corresponding image elements have the color value “white”. Accordingly, the color value of the image element having the coordinates (1,4) of the combined synthetic image is set to “white”.

For example, the color value for the image element having the coordinates (7,10) of the synthetic image S1′ is “black”. The color value for the corresponding image element having the coordinates (7,10) of the synthetic image S2′ is also “black”. The color value for the corresponding image element having the coordinates (7,10) of the synthetic image S3′ is “white”. The majority of the corresponding image elements have the color value “black”. Accordingly, the color value of the image element having the coordinates (7,10) of the combined synthetic image is set to “black”.

There are many other ways of combining synthetic images to form a combined synthetic image (see above in the description).

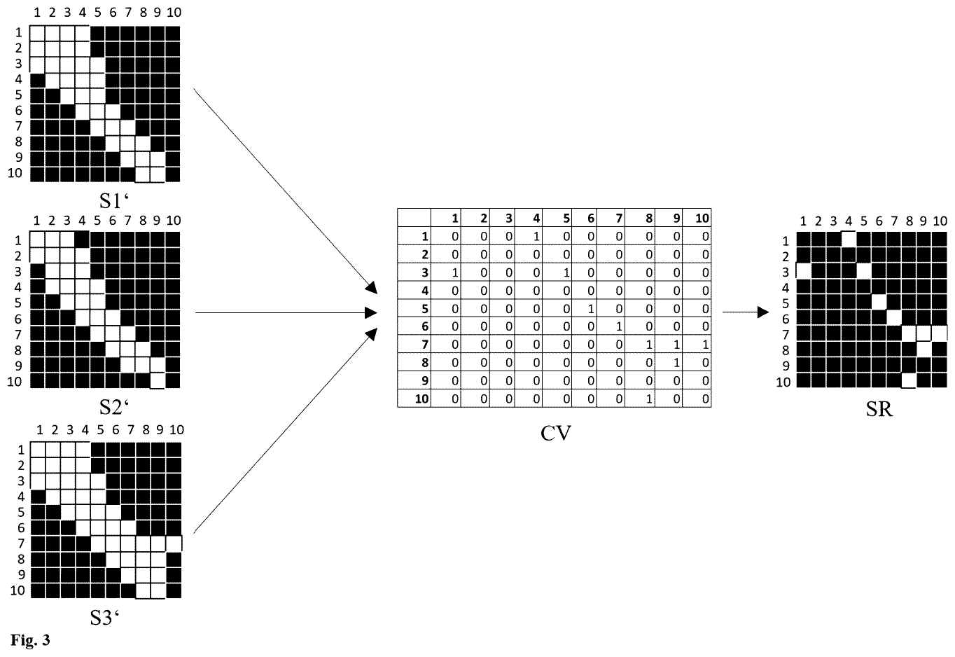

FIG. 3 shows by way of example and in schematic form the determination of the at least one confidence value. The determination of the at least one confidence value is done on the basis of corresponding image elements of the synthetic images S1′, S2′ and S3′ already shown in FIG. 2.

For each tuple of corresponding image elements, a confidence value is respectively determined. In a first step, the color values of all the image elements are determined. In the present example, the color “black” is assigned the color value “0”, as is generally customary, and the color “white” is assigned the color value “1”, as is generally customary.

The confidence value calculated for each tuple of corresponding image elements of the synthetic images S1′, S2′ and S3′ is the range of the color values.

For example, the color value for the image element having the coordinates (1,1) of the synthetic image S1′ is “1” (white). The color value for the corresponding image element having the coordinates (1,1) of the synthetic image S2′ is also “1” (white). The color value for the corresponding image element having the coordinates (1,1) of the synthetic image S3′ is also “1” (white). The range for the tuple of corresponding image elements is thus 1-1=0.

For example, the color value for the image element having the coordinates (1,4) of the synthetic image S1′ is “1” (white). The color value for the corresponding image element having the coordinates (1,4) of the synthetic image S2′ is “0” (black). The color value for the corresponding image element having the coordinates (1,4) of the synthetic image S3′ is “1” (white). The range for the tuple of corresponding image elements is thus 1-0=1.

For example, the color value for the image element having the coordinates (7,10) of the synthetic image S1′ is “0” (black). The color value for the corresponding image element having the coordinates (7,10) of the synthetic image S2′ is also “0” (black). The color value for the corresponding image element having the coordinates (7,10) of the synthetic image S3′ is “1” (white). The range for the tuple of corresponding image elements is thus 1−0=1.

The confidence values are listed in table CV.

The confidence values thus determined correlate negatively with trustworthiness.

On the basis of the confidence values, a confidence representation can be determined. In the example shown in FIG. 3, the color value of each image element in the confidence representation SR is set to the corresponding confidence value of the tuple of corresponding image elements. For example, the image element having the coordinates (1,1) in the confidence representation receives the color black, whereas the image elements having the coordinates (1,4) and (7,10) receive the color white. Using the confidence representation SR, a user (e.g. a doctor) can immediately identify which image elements are certain (black) and which are uncertain (white). Regions where many white image elements are present in the confidence representation SR should be less trusted by the user.

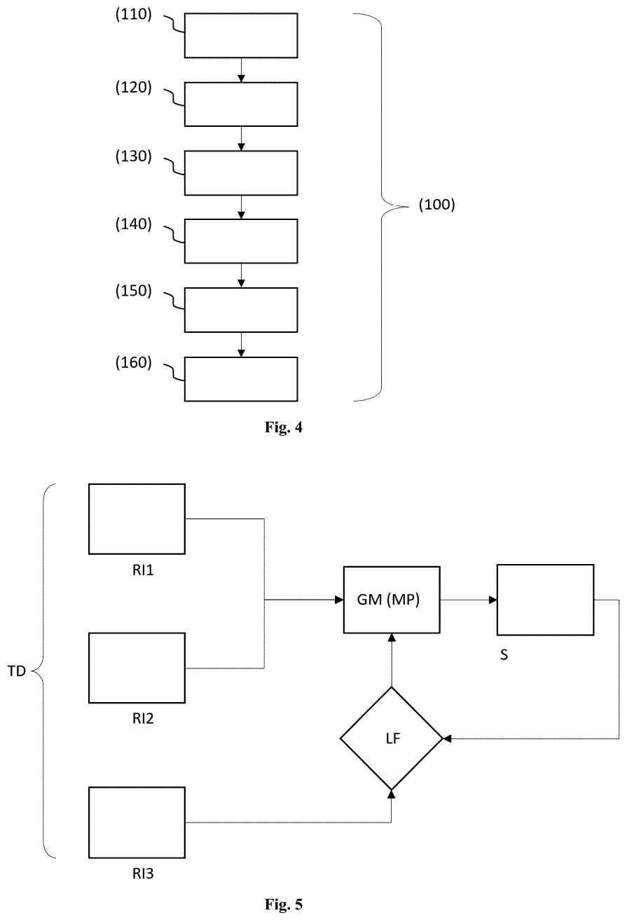

FIG. 4 shows one embodiment of the method of the present disclosure in the form of a flowchart.

The method (100) comprises the steps of:
(110) receiving at least one image of an examination region of an examination object, where the at least one image comprises a multiplicity of image elements, where each image element of the multiplicity of image elements represents a sub-region of the examination region,
(120) generating a plurality of different modifications of the at least one received image,
(130) generating a plurality of synthetic images of the examination region of the examination object on the basis of the modifications by means of a generative model, where each synthetic image comprises a multiplicity of image elements, where each image element of the multiplicity of image elements represents a sub-region of the examination region, where each image element is assigned at least one color value,
(140) determining a measure of dispersion of the color values of corresponding image elements of the generated synthetic images, where mutually corresponding image elements represent the same sub-region of the examination region,
(150) determining at least one confidence value on the basis of the determined measure of dispersion,
(160) outputting the at least one confidence value and/or an item of information based on the at least one confidence value.

As described, the generative model described in this description can be a trained machine-learning model. FIG. 5 shows by way of example and in schematic form a method for training such a machine-learning model.

The training of the generative model GM is done using training data TD. The training data TD comprise, for each reference object of a multiplicity of reference objects, at least one reference image of the reference region of the reference object in at least one first state as input data and one reference image of the reference region of the reference object in at least one state different from the first state. The terms “multiplicity of reference objects” and “plurality of reference objects” as used herein may mean more than 10 and even more than 100 reference objects.

The term “reference” is used herein to distinguish the training phase from the inference phase of the trained model for generation of synthetic images.

A “reference image” is an image used for training of the model. The “reference object” is an object from which the reference image stems. The reference object is usually, like the examination object, an animal or a human, preferably a human. The reference region is a part of the reference object. Preferably, the reference region is the same part as the examination region of the examination object.

The term “reference” otherwise, however, has no limitation on meaning. Statements made in this description concerning the at least one received image apply analogously to each reference image; statements made in this description concerning the examination object apply analogously to each reference object; statements made in this description concerning the examination region apply analogously to the reference region.

In the example shown in FIG. 5, one set of training data TD of one reference object is shown; normally, the training data TD comprise a multiplicity of these data sets for a multiplicity of reference objects. In the example shown in FIG. 5, the training data TD comprise a first reference image RI1, a second reference image RI2 and a third reference image RI3.

The first reference image RI1 represents the reference region of the reference object in a first state; the second reference image RI2 represents the reference region of the reference object in a second state; the third reference image RI3 represents the reference region of the reference object in a third state. The first state, the second state and the third state usually differ from each other. For example, the state can represent an amount of contrast agent that is or has been introduced into the reference region. For example, the state can represent a time before and/or after administration of a contrast agent.

For example, the first reference image RI1 can represent the reference region without administration or after administration of a first amount of a contrast agent, the second reference image RI2 can represent the reference region after administration of a second amount of the contrast agent, and the third reference image RI3 can represent the reference region after administration of a third amount of the contrast agent. The first amount can be less than the second amount and the second amount can be less than the third amount (see for example WO 2019/074938 A1, WO 2022/184297 A1).

For example, the first reference image RI1 can represent the reference region before administration or in a first period of time after administration of a contrast agent, the second reference image RI2 can represent the reference region in a second period of time after administration of the contrast agent, and the third reference image RI3 can represent the reference region in a third period of time after administration of the contrast agent (see, for example, WO 2021/052896 A1, WO 2021/069338 A1).

The first reference image RI1 and the second reference image RI2 serve as input data in the example shown in FIG. 5; they are fed to the generative model GM. The generative model GM is configured to generate, on the basis of the first reference image RI1 and the second reference image RI2 and on the basis of model parameters MP, a synthetic image S. The synthetic image S should approximate the third reference image RI3 as far as possible. This means that the third reference image RI3 acts in the example shown in FIG. 5 as target data (ground truth).

The synthetic image S generated by the generative model GM is compared with the third reference image RI3. A loss function LF is used to quantify differences between the synthetic image S and the third reference image RI3. For each pair of a synthetic image and a third reference image, a loss value can be calculated using the loss function LF.

In an optimization procedure, the loss value and hence the differences between the synthetic image S generated by the generative model and the third reference image RI3 can be reduced by modification of model parameters MP.

The process is repeated for a multiplicity of reference objects.

When the loss values reach a predefined minimum or the loss values cannot be reduced further by modification of model parameters, the training can be ended. The trained model can be stored, transmitted to a separate computer system and/or used to generate synthetic images for (new) objects (examination objects).

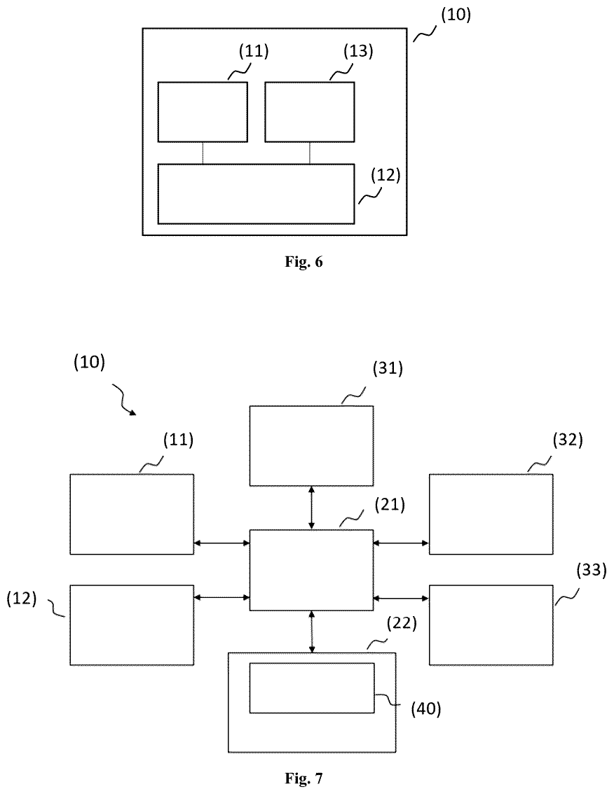

FIG. 6 shows by way of example and in schematic form a computer system according to the present disclosure.

A “computer system” is an electronic data processing system that processes data by means of programmable calculation rules. Such a system typically comprises a “computer”, which is the unit that includes a processor for carrying out logic operations, and peripherals.

In computer technology, “peripherals” refers to all devices that are connected to the computer and are used for control of the computer and/or as input and output devices. Examples thereof are monitor (screen), printer, scanner, mouse, keyboard, drives, camera, microphone, speakers, etc. Internal ports and expansion cards are also regarded as peripherals in computer technology.

The computer system (10) shown in FIG. 6 comprises a receiving unit (11), a control and calculation unit (12) and an output unit (13).

The control and calculation unit (12) serves for control of the computer system (10), for coordination of the data flows between the units of the computer system (10), and for the performance of calculations.

The control and calculation unit (12) is configured to:
cause the receiving unit (11) to receive at least one image of an examination region of an examination object, wherein the at least one image comprises a plurality of image elements, wherein each image element of the plurality of image elements represents a sub-region of the examination region;
generate a plurality of modifications of the at least one received image;
generate a plurality of synthetic images of the examination region of the examination object on the basis of the modifications by means of a generative model, wherein each synthetic image comprises a plurality of image elements, wherein each image element of the plurality of image elements represents a sub-region of the examination region, wherein each image element is assigned at least one color value;
determine a measure of dispersion of the color values of corresponding image elements of the generated synthetic images, wherein mutually corresponding image elements represent the same sub-region of the examination region;
determine at least one confidence value on the basis of the measure of dispersion; and
cause the output unit (13) to output the at least one confidence value and/or an item of information based on the at least one confidence value.

FIG. 7 shows by way of example and in schematic form a further embodiment of the computer system. The computer system (10) comprises a processing unit (21) connected to a memory (22). The processing unit (21) and the memory (22) form a control and calculation unit, as shown in FIG. 6.

The processing unit (21) may comprise one or more processors alone or in combination with one or more memories. The processing unit (21) may be customary computer hardware that is able to process information such as digital images, computer programs and/or other digital information. The processing unit (21) normally consists of an arrangement of electronic circuits, some of which can be designed as an integrated circuit or as a plurality of integrated circuits connected to one another (an integrated circuit is sometimes also referred to as a “chip”). The processing unit (21) may be configured to execute computer programs that can be stored in a working memory of the processing unit (21) or in the memory (22) of the same or of a different computer system.

The memory (22) may be customary computer hardware that is able to store information such as digital images (for example representations of the examination region), data, computer programs and/or other digital information either temporarily and/or permanently. The memory (22) may comprise a volatile and/or non-volatile memory and may be fixed in place or removable. Examples of suitable memories are RAM (random access memory), ROM (read-only memory), a hard disk, a flash memory, an exchangeable computer floppy disk, an optical disc, a magnetic tape or a combination of the aforementioned. Optical discs can include compact discs with read-only memory (CD-ROM), compact discs with read/write function (CD-R/W), DVDs, Blu-ray discs and the like.

The processing unit (21) may be connected not just to the memory (22), but also to one or more interfaces (11, 12, 31, 32, 33) in order to display, transmit and/or receive information. The interfaces may comprise one or more communication interfaces (11, 32, 33) and/or one or more user interfaces (12, 31). The one or more communication interfaces may be configured to send and/or receive information, for example to and/or from an MRI scanner, a CT scanner, an ultrasound camera, other computer systems, networks, data memories or the like. The one or more communication interfaces may be configured to transmit and/or receive information via physical (wired) and/or wireless communication connections. The one or more communication interfaces may comprise one or more interfaces for connection to a network, for example using technologies such as mobile telephone, wifi, satellite, cable, DSL, optical fibre and/or the like. In some examples, the one or more communication interfaces may comprise one or more close-range communication interfaces configured to connect devices having close-range communication technologies such as NFC, RFID, Bluetooth, Bluetooth LE, ZigBee, infrared (e.g. IrDA) or the like.

The user interfaces may include a display (31). A display (31) may be configured to display information to a user. Suitable examples thereof are a liquid crystal display (LCD), a light-emitting diode display (LED), a plasma display panel (PDP) or the like. The user input interface(s) (11, 12) may be wired or wireless and may be configured to receive information from a user in the computer system (1), for example for processing, storage and/or display. Suitable examples of user input interfaces are a microphone, an image- or video-recording device (for example a camera), a keyboard or a keypad, a joystick, a touch-sensitive surface (separate from a touchscreen or integrated therein) or the like. In some examples, the user interfaces may contain an automatic identification and data capture technology (AIDC) for machine-readable information. This can include barcodes, radiofrequency identification (RFID), magnetic strips, optical character recognition (OCR), integrated circuit cards (ICC) and the like. The user interfaces may in addition comprise one or more interfaces for communication with peripherals such as printers and the like.

One or more computer programs (40) may be stored in the memory (22) and executed by the processing unit (21), which is thereby programmed to fulfil the functions described in this description. The retrieving, loading and execution of instructions of the computer program (40) may take place sequentially, such that an instruction is respectively retrieved, loaded and executed. However, the retrieving, loading and/or execution may also take place in parallel.

The computer system of the present disclosure may be designed as a laptop, notebook, netbook and/or tablet PC; it may also be a component of an MRI scanner, a CT scanner or an ultrasound diagnostic device.

1. A computer-implemented method comprising:
receiving at least one image (I1, I2) of an examination region of an examination object, wherein the at least one image (I1, I2) comprises a plurality of image elements, wherein each image element of the plurality of image elements represents a sub-region of the examination region;
generating a plurality of different modifications (M11, M12, M13, M21, M22, M23) of the at least one received image (I1, I2);
generating a plurality of synthetic images (S1, S2, S3) of the examination region of the examination object on the basis of the modifications (M11, M12, M13, M21, M22, M23) by means of a generative model (GM), wherein each synthetic image (S1, S2, S3) comprises a plurality of image elements, wherein each image element of the plurality of image elements represents a sub-region of the examination region, wherein each image element is assigned at least one color value;
determining a measure of dispersion of the color values of corresponding image elements of the generated synthetic images (S1, S2, S3), wherein mutually corresponding image elements represent the same sub-region of the examination region;
determining at least one confidence value on the basis of the determined measure of dispersion; and
outputting the at least one confidence value or an item of information based on the at least one confidence value.

2. The method according to claim 1, comprising:
receiving a first image (I1) and a second image (I2) of the examination region of the examination object;
generating a first modification (M11) of the first image (I1), a second modification (M12) of the first image (I1), a first modification (M21) of the second image (I2) and a second modification (M22) of the second image (I2);
generating a first synthetic image (S1) on the basis of the first modification (M11) of the first image (I1) and the first modification (M21) of the second image (I2) by means of the generative model;
generating a second synthetic image (S2) on the basis of the second modification (M12) of the first image (I1) and the second modification (M22) of the second image (I2) by means of the generative model;
determining a respective measure of dispersion of the color values of corresponding image elements of the generated synthetic images for each tuple of corresponding image elements;
determining a respective confidence value for each tuple of corresponding image elements of the generated synthetic images on the basis of the respective measure of dispersion of the tuple; and
outputting the confidence values or an item of information based on the confidence values.

3. The method according to claim 1, comprising:
receiving a number m of images (I1, I2), wherein m is a positive integer;
generating a number p of modifications (M11, M12, M13, M21, M22, M23) of each of the m images (I1, I2), where p is an integer greater than one;
generating a respective synthetic image (S1, S2, S3) on the basis of a respective modification (M11, M12, M13, M21, M22, M23) of each of the m images (I1, I2);
determining a respective measure of dispersion of the color values of corresponding image elements for each tuple of corresponding image elements of the generated synthetic images;
determining a respective confidence value for each tuple of corresponding image elements of the generated synthetic images on the basis of the measure of dispersion of the tuple; and
outputting the confidence values or an item of information based on the confidence values.

4. The method according to claim 1, further comprising:
generating a synthetic image (SI) of the examination region of the examination object on the basis of the at least one received image (I1, I2).

5. The method according to claim 1, wherein the measure of dispersion is, or is derived from, at least one of a range, a standard deviation, a variance, a sum of squared deviations, a coefficient of variation, a mean absolute deviation, a quantile range, an interquantile range, a mean absolute deviation from a median, a median absolute deviation and a geometric standard deviation of the color values of corresponding image elements.

6. The method according to claim 1, wherein each modification (M11, M12, M13, M21, M22, M23) is generated by image augmentation of the at least one received image (I1, I2).

7. The method according to claim 6, wherein the image augmentation comprises at least one of reflection, rotation, translation, scaling, homothety, shearing, distortion, addition of noise, variation of color values, setting of color values to zero or some other value or to a random value within defined limits, row-by-row shifting of image elements by a defined absolute value or by a random absolute value within defined limits, column-by-column shifting of image elements by a defined absolute value or by a random absolute value within defined limits, reduction or increase of color values by a defined absolute value or by a random absolute value within defined limits, changing of the sharpness or contrast of an image, and partial blending of two or more images of the at least one received image.

8. The method according to claim 1, further comprising:
generating a combined synthetic image (S) on the basis of the synthetic images (S1, S2, S3), wherein the generation of the combined synthetic image (S) comprises:
for each tuple of corresponding image elements of the synthetic images (S1, S2, S3): determining an average color value by averaging of the color values of the corresponding image elements and setting the average color value as the color value of the corresponding image element of the combined synthetic image (S).

9. The method according to claim 8, further comprising:
outputting the combined synthetic image (S) and transmitting the combined synthetic image (S) to a separate computer system; or
outputting a synthetic image (SI) generated on the basis of the at least one received image (I1, I2) and transmitting the synthetic image (SI) generated on the basis of the at least one received image (I1, I2) to a separate computer system.

10. The method according to claim 9, further comprising:
generating a confidence representation (SR), wherein the confidence representation (SR) comprises a plurality of image elements, wherein each image element of the plurality of image elements represents a sub-region of the examination region, wherein each image element has a color value, wherein the color value correlates with the respective confidence value of each tuple of corresponding image elements of the synthetic images; and
outputting the confidence representation (SR), in a superimposition with the combined synthetic image (S) or with the synthetic image (SI) generated on the basis of the at least one received image (I1, I2), and transmitting the confidence representation (SR) to a separate computer system.

11. The method according to claim 8, further comprising:
determining a confidence value for one or more sub-regions of the combined synthetic image (S) or for the entire combined synthetic image (S); and
outputting the confidence value or an item of information based on the confidence value.

12. The method according to claim 1, wherein the examination object is a human or an animal.

13. The method according to claim 9, wherein the at least one received image (I1, I2) is at least one medical image, and each synthetic image (S1, S2, S3, SI) or the combined synthetic image (S) is a synthetic medical image.

14. The method according to claim 9,
wherein the at least one received image (I1, I2) comprises a first radiological image and a second radiological image, wherein the first radiological image represents the examination region of the examination object without a contrast agent or after administration of a first amount of the contrast agent and the second radiological image represents the examination region of the examination object after administration of a second amount of the contrast agent, and
wherein each synthetic image (S1, S2, S3, SI) or the combined synthetic image (S) is a synthetic radiological image, wherein each synthetic image (S1, S2, S3, S1) or the combined synthetic image (S) represents the examination region of the examination object after administration of a third amount of the contrast agent, wherein the second amount is different from the first amount and the third amount is different from the first amount and the second amount.

15. The method according to claim 9,
wherein the at least one received image (I1, I2) comprises a first radiological image and a second radiological image, wherein the first radiological image represents the examination region of the examination object in a first period of time before or after administration of a contrast agent and the second radiological image represents the examination region of the examination object in a second period of time after administration of the contrast agent, and
wherein each synthetic image (S1, S2, S3, S1) or the combined synthetic image (S) is a synthetic radiological image, wherein each synthetic image (S1, S2, S3, S1) or the combined synthetic image (S) represents the examination region of the examination object in a third period of time after administration of the contrast agent, wherein the second period of time follows the first period of time and the third period of time follows the second period of time.

16. A computer system comprising:
a receiving unit;
a control and calculation unit; and
an output unit;
wherein the control and calculation unit is configured to:
cause the receiving unit to receive at least one image (I1, I2) of an examination region of an examination object, wherein the at least one image (I1, I2) comprises a plurality of image elements, wherein each image element of the plurality of image elements represents a sub-region of the examination region;
generate a plurality of different modifications (M11, M12, M13, M21, M22, M23) of the received image (I1, I2);
generate a plurality of synthetic images (S1, S2, S3) of the examination region of the examination object on the basis of the modifications (M11, M12, M13, M21, M22, M23) by means of a generative model (GM), wherein each synthetic image (S1, S2, S3) comprises a plurality of image elements, wherein each image element of the plurality of image elements represents a sub-region of the examination region, wherein each image element is assigned at least one color value;
determine at least one confidence value on the basis of the color values of mutually corresponding image elements of the modifications (M11, M12, M13, M21, M22, M23), wherein the mutually corresponding image elements represent the same sub-region of the examination region; and
cause the output unit to output the at least one confidence value or an item of information based on the at least one confidence value.

17. A computer-readable storage medium comprising a computer program which, when loaded into a working memory of a computer system, causes the computer system to execute:
receiving at least one image (I1, I2) of an examination region of an examination object, wherein the at least one image (I1, I2) comprises a plurality of image elements, wherein each image element of the plurality of image elements represents a sub-region of the examination region;
generating a plurality of different modifications (M11, M12, M13, M21, M22, M23) of the at least one received image (I1, I2);
generating a plurality of synthetic images (S1, S2, S3) of the examination region of the examination object on the basis of the modifications (M11, M12, M13, M21, M22, M23) by means of a generative model (GM), wherein each synthetic image (S1, S2, S3) comprises a plurality of image elements, wherein each image element of the plurality of image elements represents a sub-region of the examination region, wherein each image element is assigned at least one color value;
determining a measure of dispersion of the color values of corresponding image elements of the generated synthetic images (S1, S2, S3), wherein mutually corresponding image elements represent the same sub-region of the examination region;
determining at least one confidence value on the basis of the determined measure of dispersion; and
outputting the at least one confidence value or an item of information based on the at least one confidence value.
